(19) United States
(12) Patent Application Publication
(10) Pub. No.: US 2020/0390647 A1
(43) Pub. Date: Dec. 17, 2020

(54) DEVICE FOR ASSISTING CPR

(71) Applicant: Zvonko Peric, Hudson, OH (US)

(72) Inventor: Zvonko Peric, Hudson, OH (US)

(21) Appl. No.: 16/899,104

(22) Filed: Jun. 11, 2020

Related U.S. Application Data
(60) Provisional application No. 62/859,780, filed on Jun. 11, 2019.

(51) Int. Cl. A61H 31/00

(52) U.S. Cl. CPC A61H 31/007; A61H 2201/0157; A61H 2201/14; A61H 2203/0456; A61H 2201/1654; A61H 2201/1664; A61H 2201/1621

(57) ABSTRACT

A device for assisting CPR comprising a base, a lever arm having first and second ends, and a middle portion, one or more chest pads affixed to said middle portion of said lever arm, a plurality of anchor points set into said base, and a pair of straps connecting said anchor points to said first end of lever arm, creating a fulcrum at said first end; wherein when in use a user grips said lever arm at said second end.

### BACKGROUND OF THE INVENTION

Cardiopulmonary resuscitation (CPR) is an emergency procedure that combines chest compressions often with artificial ventilation in an effort to manually preserve intact brain function until further measures are taken to restore spontaneous blood circulation and breathing in a person who is in cardiac arrest.

CPR involves chest compressions for adults between 5 cm (2.0 in) and 6 cm (2.4 in) deep and at a rate of at least 100 to 120 per minute. The rescuer may also provide artificial ventilation by either exhaling air into the subject's mouth or nose (mouth-to-mouth resuscitation) or using a device that pushes air into the subject's lungs (mechanical ventilation). Current recommendations place emphasis on early and high-quality chest compressions over artificial ventilation. Chest compression to breathing ratios is set at 30 to 2 in adults.

### SUMMARY OF THE INVENTION

The invention relates to a device for assisting CPR comprising a base, a lever arm having first and second ends, and a middle portion, one or more chest pads affixed to said middle portion of said lever arm, a plurality of anchor points set into said base, and a pair of straps connecting said anchor points to said first end of lever arm, creating a fulcrum at said first end; wherein when in use a user grips said lever arm at said second end.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a top view of the CPR aid base and pressure arm,

FIG. 2 is a perspective view of the device shown in FIG. 1;

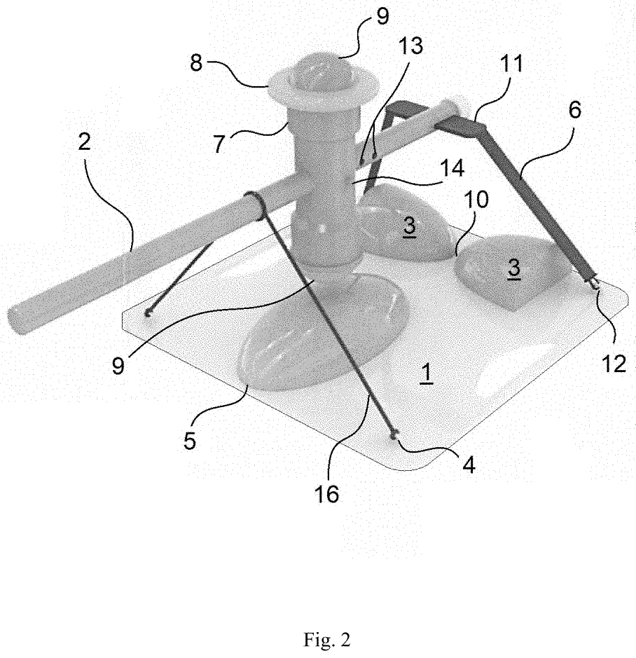

FIG. 3 is a side view of the device shown in FIG. 1 in its alternate configuration; and

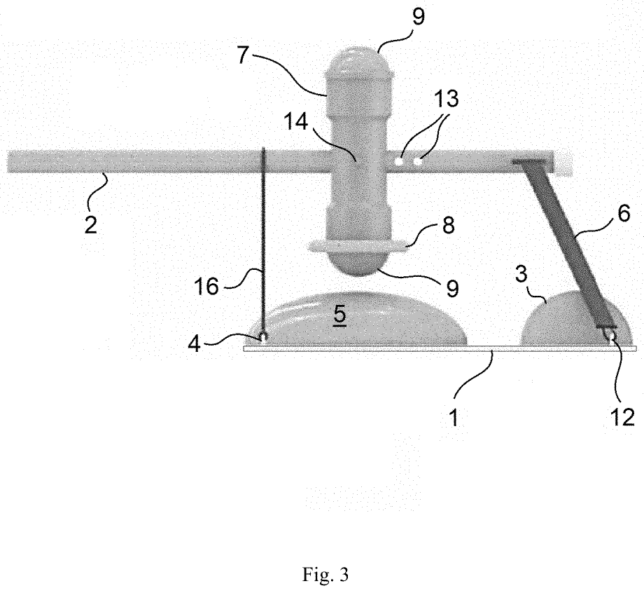

FIG. 4 is a close-up side view of the pressure arm, pin, and pads,

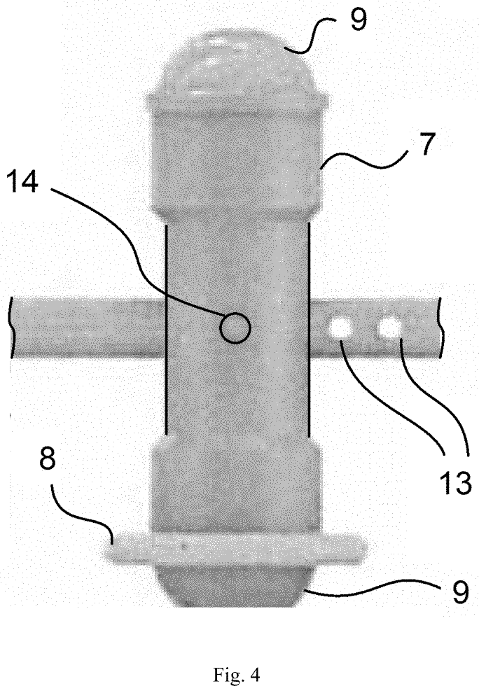

### DETAILED DESCRIPTION OF THE INVENTION

The invention is a device for assisting CPR, or a CPR aid. The CPR aid is intended for home use. It is easy to set up and use. Cardiopulmonary resuscitation is less effective, or ineffective, on a soft surface, such as a bed or couch. The CPR aid can be helpful for assisting with heavy patients. For example, if a patient, such as a spouse or elderly parent, is overweight, or if the caretaker is significantly smaller than the patient, or is frail or weak themselves, it would be impossible, or nearly so, to lower the patient from the bed on the floor (or other hard surface) to administer CPR.

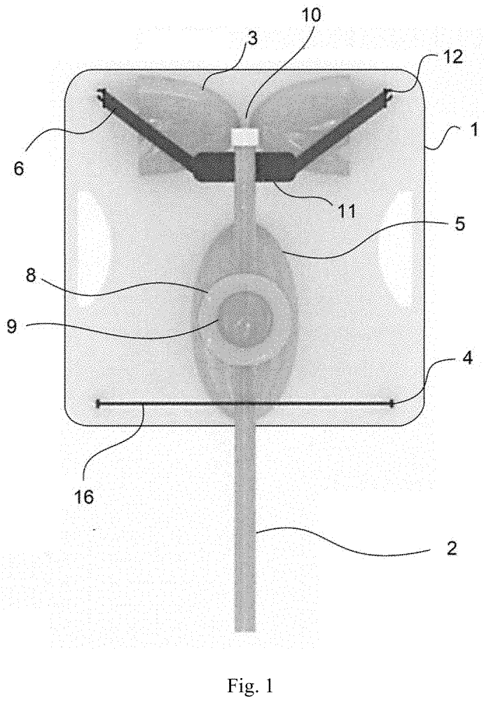

As shown in FIG. 1, the device comprises a base plate or board 1. The plate can be used directly under a patient, or underneath a mattress of a bed. The CPR aid gives a hard surface beneath the patient, allowing CPR to be administered while the patient remains in bed.

The CPR aid further features a handle/pressure arm 2 with two rubber tubes 7 that hold cushioned chest pads 9. The cushioned pads 9 contact the chest of the patient. A pair of straps 6 connect the handle to the base board 1. When the user actuates handle 2, tension is exerted in the straps 6, creating a fulcrum in a lever action, and pressure is applied to the pads 9, which apply pressure to the chest of a patient, administering CPR compressions.

The rubber ring 8 has the purpose of exerting greater pressure on larger (thicker) patients. A ringless chest pad 9 is used for women's breasts and young people. The device is adjustable for muscle and a woman's chest. The tubes 7 can slide along the handle 2 to adjust the pad to rest on the proper area of the patient's chest, and can be rotated about the handle 2 to allow the user to choose whether to use the rubber ring 8 or not. Once the desired end is chosen, a pin 14 can be inserted into adjustment hole 13 to lock the device in position and prevent rotation and sliding. The pin 14 can be stored in a pin holder (not shown) when not in use.

The spinal/back support cushion 5 supports and positions the spine of the patient to be closer to the heart. The heart is then essentially sandwiched between the spine and sternum in this position. In this way, force is exerted on both sides of the heart, forcing increased blood to the brain, which aids in resuscitation of the patient. The back support cushion 5 is movable can be set vertically, horizontally, or can be removed completely.

When in use, the patient places his or her neck on the head support cushions 3. This positions the head in the space 10 between the head support cushions, and positions the head to lean back so the throat and airways are opened.

The built-in anchor points 4 are positioned at the corners on all four sides. The connecting straps 6 attach to the anchor points 4 and the handle 2. The straps 6 are strong and can be extended and shortened if needed to adjust the device so that the pressure pads 9 are positioned correctly at the patient's chest. This allows for versatility so that a person who can assist with a patient may change positions when resuscitating the patient's heart. The orientation of the straps and handle can be changed so that its position can be up, down, left, or right. The straps 6 are secured to the anchor points 4 via fasteners 12. Optional secondary straps 16 are elastic and help keep the pressure arm bar 2 in the correct position during administration of CPR.

Adjustment means 11 allows the straps 6 to sized as need to properly fit the patient. The hammer lever 2 can easily be adjusted to work with a patient of a most sizes. Setting up the device for the patient can be achieved in about thirty seconds.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A device for assisting CPR comprising
a base,
a lever arm having first and second ends, and a middle portion,
one or more chest pads affixed to said middle portion of said lever arm,
a plurality of anchor points set into said base, and
a pair of straps connecting said anchor points to said first end of lever arm, creating a fulcrum at said first end;
wherein when in use a user grips said lever arm at said second end.

2. The device of claim 1 further comprising a second set of anchor points and positioning straps that connect to the second set of anchor points and the middle portion of said lever arm.
